(19) United States
(12) Patent Application Publication
(10) Pub. No.: US 2013/0024338 A1
(43) Pub. Date: Jan. 24, 2013

(54) CLAIMS DATA ANALYSIS

(71) Applicants: BRETT A. NIELSON, SPANGLE, WA (US); RANGARAJAN UMAMAHESWARAN, SIMI VALLEY, CA (US)

(72) Inventors: BRETT A. NIELSON, SPANGLE, WA (US); RANGARAJAN UMAMAHESWARAN, SIMI VALLEY, CA (US)

(73) Assignee: BANK OF AMERICA CORPORATION, CHARLOTTE, NC (US)

(21) Appl. No.: 13/186,578

(22) Filed: Jul. 20, 2011

(51) Int. Cl. G06Q 40/00; G06Q 99/00

(52) U.S. Cl. 705/35; 705/325

(57) ABSTRACT

Embodiments of the invention provide for claims data analysis. The methods, apparatus and computer program products provide for receiving claims data pertaining to an abnormal event related to at least one customer account held at an entity and determining which individuals associated with the entity interacted with the customer accounts in the claims data. In addition, several embodiments described herein contemplate analysis of additional information associated with each claim to detect relationships amongst and between claims, customer accounts, and individuals who interacted with customer accounts that are the subject of claims. In such embodiments, investigation of claims may be targeted and allow for a more efficient identification of potentially culpable individuals and rapid exoneration of innocent individuals.

### FIELD

In general, embodiments of the invention relate to customer claim investigation and, more particularly, methods, devices and computer program products for a claims data analysis that identifies individuals associated with an entity who have interacted with customer accounts held at an entity, where the accounts are the subject of a claim.

### BACKGROUND

As people have adopted increasingly busy lifestyles and gained high levels of comfort with technology, customers of many entities have demanded the ability to conduct personal business over the phone, over the Internet, and through other technological means. In response to this demand, many businesses, including financial institutions, have augmented their traditional, in-person business facilities with online presences, customer call centers, and other avenues for conducting business remotely.

At the same time, technology has changed the way that employees, managers, and other individuals associated with a business entity store, access, service, and handle customer information, including potentially sensitive customer information. Customer demand for increased accessibility to business services, coupled with the need for increased access to information by employees who may be in numerous different physical locations can add layers of complexity in determining who accessed customer information, what information was accessed, and how that information may have been used.

Unfortunately, the sophistication of identity thieves and other criminals who seek to misappropriate, misuse, and otherwise exploit customer information for improper purposes has grown in parallel with the popularity of services that allow customers to conduct business online, over the phone, or through other technological means. While the perceived threat of identity theft, account fraud, and other attacks on customer accounts have become the subject of everyday conversation, many customers still fail to take adequate steps to protect their own sensitive information, and instead rely on the businesses that they interact with to protect such information. As a result, even in situations where an external actor is the source of a fraudulent misappropriation of customer information or money, the impacted customers often blame a business for the event, subjecting the business to significant reputational and other risk.

Financial institutions, such as banks, are especially at risk for the loss of reputation and customer confidence that often accompanies an event stemming from the misappropriation of customer information. Given the high level of sophistication of many perpetrators, and the speed at which negative news can travel among customers, potential customers, and the public at large, the need to be able to rapidly identify potential security breaches, exonerate innocent actors, and narrow the target of an investigation has arisen.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, as described in further detail below, embodiments of the invention provide for claims data analysis. The methods, apparatus and computer program products described in more detail below provide for receiving claims data, wherein each claim pertains to an abnormal event related to at least one customer account held and an entity, and determining which individuals associated with that entity interacted with the customer accounts in the claims data. In addition, some of the embodiments contemplate examining an attribute set associated with a claim and determining whether a relationship exists between the attribute set and an individual who has interacted with a customer account in the claims data.

A method for claims data analysis defines a first embodiment of the invention. In example implementations, methods include receiving, via a computing device, claims data, wherein the claims data comprises a plurality of claims, each claim pertaining to an abnormal event related to at least one customer account held at an entity; determining, via a computing device processor, which individuals associated with the entity interacted with the customer accounts in the claims data during a predetermined time period prior to the abnormal event or notification of the abnormal event; and providing, via a computing device processor, for a suspect list that includes the individuals determined to have interacted with a customer account in the claims data.

In some further example implementations, such methods also include examining via a computing device processor an attribute set associated with a claim; and determining via a computing device processor whether a relationship exists between the attribute set associated with the claim and an individual determined to have interacted with a customer account in the claims data. Some further example implementations of such methods include, in response to determining via a computing device processor that a relationship exists between the attribute set associated with the customer claim and an individual determined to have interacted with a customer account in the claims data, referring the individual for investigation.

In example implementations that contemplate an attribute set associated with a claim, many different types of information may be included in the attribute set. It will be appreciated that any information associated with a claim may be included in the attribute set. Such information may include, but is not limited to, any information that tends to describe, classify, or clarify the claim and/or any aspect of a claim.

In some example implementations, the attribute set includes a name of a customer associated with a claim. In some of these and other example implementations, the attribute set includes a geographic area. Some example attribute sets include a distance between a location associated a first claim and a location associated with a second claim.

In some of these and other example implementations, the attribute set includes a period of time associated with a claim. In some example implementations, the attribute set comprises a time of day associated with a claim.

Some example implementations include attribute sets that include information about a customer associated with a claim. In some such implementations, the attribute set may include a job title associated with a customer. In some of these and other example implementations, the attribute set includes demographic information associated with a customer.

In some example implementations, the attribute set includes a set of banking information. It will be appreciated that such sets of banking information may include any information regarding financial institutions and/or financial information associated with a claim. In some such implementations, the banking information includes a bank name. In some of these and other such implementations, the banking information includes a bank branch identification number. In still other example implementations, the banking information includes an employee name, including but not limited to an employee at a financial institution that may have participated in potentially suspect transactions. In some example implementations, the banking information includes a check number, including but not limited to a check number associated with a falsified document or an unauthorized check. Some implementations include a set of banking information that includes a bank routing number.

An apparatus for analyzing a customer claim defines a second aspect of the invention. In some example implementations of an apparatus in accordance with this aspect, the apparatus includes a computing device comprising a memory and at least one processor; and a claims data analysis application stored in the memory, executable by the processor, and configured to: receive claims data, wherein the claims data comprises a plurality of claims, each claim pertaining to an abnormal event related to at least one customer account held at an entity; determine which individuals associated with the entity interacted with the customer accounts in the claims data during a predetermined time period prior to the abnormal event or notification of the abnormal event; and provide for a suspect list that includes the individuals determined to have interacted with a customer account in the claims data.

In some implementations of such an apparatus, the claims data analysis application is further configured to: examine an attribute set associated with a claim; and determine whether a relationship exists between the attribute set associated with the claim and an individual determined to have interacted with a customer account in the claims data.

In additional example implementations of an apparatus in accordance with this aspect of the invention, the claims data analysis application is further configured to, in response to determining via a computing device processor that a relationship exists between the attribute set associated with the claim and an individual determined to have interacted with a customer account in the claims data, refer the individual for investigation.

In example implementations that contemplate an attribute set associated with a claim, any of the attribute sets discussed in relation to methods for claims data analysis may be used in example implementations of an apparatus in accordance with this aspect of the invention. In some example implementations, the attribute set includes information about a customer. In some such implementations, the attribute set may include, but is not limited to, a name of a customer associated with a claim, a job title associated with a customer who is associated with a claim, and/or demographic information associated with a customer who is associated with a claim.

In some of these and in other example implementations, the attribute set includes information about locations associated with a claim. In some example implementations, the attribute set includes a geographic area associated with a claim. In some example implementations, the attribute set includes a distance between a location associated with a first claim and a location associated with a second claim. In some of these and in other example implementations, the attribute set includes a period of time and/or a time of day associated with a claim.

In some example implementations of an apparatus in accordance with this aspect of the invention, the attribute set includes one or more pieces of banking information. Examples of banking information that may be included in such implementations include, but are not limited to, a bank name, a bank branch identification number, an employee name, a check number, and a bank routing number.

A computer program product defines a third aspect of the invention. In example implementations of such a computer program product, the computer program product includes: a non-transitory computer-readable medium, which in turn includes a first set of codes for causing a computer processor to be configured for receiving claims data, wherein the claims data comprises a plurality of claims, each claim pertaining to an abnormal event related to at least one customer account held at an entity; a second set of codes for causing a computer processor to be configured for determining which individuals associated with the entity interacted with the customer accounts in the claims data during a predetermined time period prior to the abnormal event or notification of the abnormal event; and a third set of codes for causing a computer processor to be configured for providing for a suspect list that includes the individuals determined to have interacted with a customer account in the claims data.

In some implementations of computer program products in accordance with this aspect of the invention, the computer program product further includes: a fourth set of codes for causing a computer processor to be configured for examining an attribute set associated with a claim; and a fifth set of codes for causing a computer processor to be configured for determining whether a relationship exists between the attribute set associated with the claim and an individual determined to have interacted with a customer account in the claims data.

In some such implementations, the computer program product further includes a sixth set of codes for causing a computer processor to be configured for, in response to determining that a relationship exists between the attribute set associated with the claim and an individual determined to have interacted with a customer account in the claims data, referring the individual for investigation.

In implementations of a computer program that contemplate an attribute set associated with a claim, any of the attributes discussed herein may be included in attribute sets used in example implementations. In some such examples, an attribute set may include, but is not limited to, a name of a customer associated with a claim, a geographic area, a distance between a location associated a first claim and a location associated with a second claim, a period of time, a time of day, a job title associated with a customer, a set of banking information, and/or demographic information associated with a customer.

In some example implementations where an attribute set includes banking information, any of the banking information discussed herein may be included. In some such example implementations, the banking information included in the attribute set may include, but is not limited to, a bank name, a bank branch identification number, an employee name, a check number, and/or a bank routing number.

Thus, as described in further detail below, embodiments of the invention provide for claims data analysis. The methods, apparatus and computer program products described in more detail below provide for receiving claims data, wherein each claim pertains to an abnormal event related to at least one customer account held by an entity, and determining which individuals associated with that entity interacted with the customer accounts in the claims data. In addition, some of the embodiments contemplate examining an attribute set associated with a claim and determining whether a relationship exists between the attribute set and an individual who has interacted with a customer account in the claims data.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a block diagram of a method for claims data analysis, in accordance with embodiments of the present invention.

FIG. 2 is a more detailed block diagram of method for claims data analysis, in accordance with embodiments of the present invention.

FIG. 3 is a block diagram of an apparatus configured to perform claims data analysis in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, or device. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, as described in further detail below, embodiments of the invention provide for claims data analysis. The methods, apparatus and computer program products described in more detail below provide for receiving claims data, wherein each claim pertains to an abnormal event related to at least one customer account held at an entity, and determining which individuals associated with that entity interacted with the customer accounts in the claims data. In addition, some of the embodiments contemplate examining an attribute set associated with a claim and determining whether a relationship exists between the attribute set and an individual who has interacted with a customer account in the claims data.

In some example implementations, a financial institution receives a notification from a customer claiming that that an unauthorized charge has been made to the customer's account, or that some other potentially improper activity has occurred with the account. In some such implementations, the financial institution can then identify individuals who interacted with the customer's account, allowing the financial institution to identify potential events and situations during which the customer's information may have been viewed, used, accessed, or otherwise exposed.

Some embodiments of the invention are applicable to the investigation of data security breaches, such as breaches that result in the release and/or misuse of customer account information and other sensitive customer information. In some such embodiments, it will be appreciated that the focus of the investigation is largely internal to the entity that holds the customer account. In many situations, the set of individuals associated with an entity is a finite, discernable group. In such situations, the internal focus contemplated by some example embodiments allows for an investigation with a finite scope.

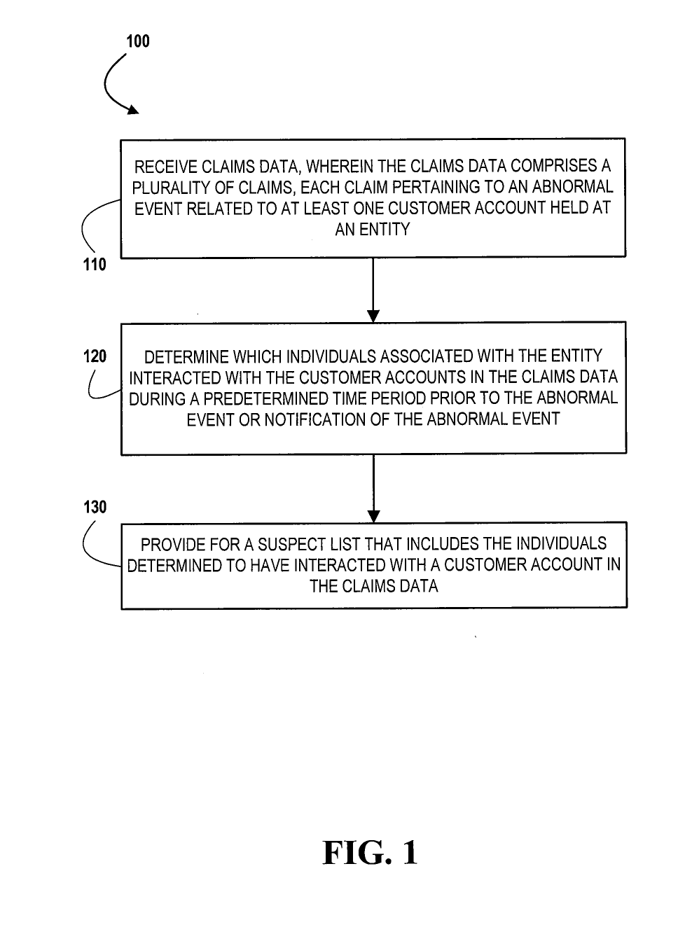

FIG. 1 is a flow chart depicting an example method 100 in accordance with an aspect of the invention. As shown in FIG. 1, element 110 includes receiving claims data, wherein the claims data comprises a plurality of claims, each claim pertaining to an abnormal event related to at least one customer account held at an entity. FIG. 1 also depicts element 120, which includes determining which individuals associated with the entity interacted with the customer accounts in the claims data during a predetermined time period prior to the abnormal event or notification of the abnormal event. Also shown in FIG. 1 is element 130, which includes providing for a suspect list that includes the individuals determined to have interacted with a customer account in the claims data.

As used herein, the term customer account refers to any set of information associated with a customer. For example, a customer account may include information such as a customer name, address, telephone number, identification number, account number, financial data, transaction history, and/or any other information associated with the customer. In some example implementations of methods similar to method 100, the customer account is a bank account, which may include some, if not all, of the information required for an individual to access funds belonging to the customer.

In some implementations of example methods, such as method 100, the term abnormal event includes, but is not limited to, any occurrence that is actually or potentially related to unauthorized access or use of a customer account. A fraudulent charge, forged check, unauthorized use of a credit card or credit card number, and misuse of identity information are each examples of an abnormal event.

As used herein, the term claim refers to any actual, constructive, or potential notice of an actual or potential occurrence. In some example implementations, a claim is a report received from a customer indicating that the customer's account has been erroneously or fraudulently charged or otherwise used. In some such implementations, and in other example implementations, the claim is generated by the entity. For example, in situations where the entity monitors account activity to detect potentially abnormal events, the entity may generate a claim for subsequent investigation.

As presented in FIG. 1, element 110 includes receiving claims data, wherein the claims data comprises a plurality of claims, each claim pertaining to an abnormal event related to at least one customer account held at an entity. In some example implementations of element 110, the information associated with a plurality of claims is compiled into claims data, which is received via a computing device. The information associated with each claim may come from any source. In some implementations, the claim originates with a customer, who may provide information regarding the abnormal event. The entity itself, or a third party may also provide information associated with a claim. For example, the entity may monitor transactions to detect potential abnormalities. With regards to third parties, law enforcement agencies, other businesses, concerned citizens, or any other individual or group may submit information associated with an abnormal event related to a customer account, including evidence of criminal activity, and/or other potentially suspicious activity involving account information.

In some example implementations of element 110, the received claims data and/or information included in the claims data is stored in memory accessible by a computing device or a processor. It will be appreciated that the claims data may be compiled over a period of time. For example, information associated with each claim pertaining to an abnormal event related to a customer account held at an entity may be received and stored in memory accessible by a computing device or processor as that information becomes available and/or known to the entity, and subsequently assembled into a set of claims data received by a computing device. In some example implementations where claims data analyses are performed periodically, some information related to one or more individual claims is compiled, stored, and/or received asynchronously with respect to information related to one or more other individual claims. However, it will also be appreciated that a set of claims data may be received during a single event, such as when claims data stored in a database is received by a computer processor or other apparatus configured to perform a claims data analysis, such as the example method 100 or other claims data analyses described herein. In some example implementations, the claims data is received as part of querying a database that contains information related to one or more claims in the plurality of claims included in the claims data.

Element 120 includes determining which individuals associated with the entity interacted with the customer accounts in the claims data during a predetermined time period prior to the abnormal event or notification of the abnormal event. In some example implementations of element 120 and/or similar steps, the individuals associated with the entity are employees of the entity, such as employees of a financial institution whose duties involve interactions with customer accounts and/or other exposure to customer account information. However, it will be appreciated that the term individuals associated with the entity is not limited to individuals in an employee relationship with the entity. Rather, the set of individuals associated with the entity could include, but is not limited to, independent contractors, managers, partners, owners, affiliates, associates, and/or any other person.

As set forth in element 120, an interaction between an individual associated with the entity and a customer account in the claims data is contemplated. An interaction between an individual and a customer account occurs whenever an individual achieves access to data in a form that could, subsequent to such access, be misused. In some situations, an interaction is coupled with an action such as printing, emailing, writing down, capturing an image of, downloading to physical storage media or otherwise making a copy of customer account information. However, it will be appreciated that an interaction does not require the individual to make a physical or digital copy of the data. It will also be appreciated that there is no intent element necessary for an interaction to occur. Rather, in many example situations, an interaction occurs in the normal course of the entity's business and within the scope of an individual's duties. For example, an interaction occurs when, in response to an inbound phone call from a customer that is routed through a customer service phone system, an associate of an entity views and/or verifies the customer's account information as part of providing service. Other examples of interactions include, but are not limited to, modifying customer account information, conducting maintenance of customer account information, printing customer account information, conducting searches of or querying a database that includes customer account information, and/or providing in-person services to a customer during which customer account information is exchanged.

In some example implementations, interactions between an individual and customer accounts are continuously monitored, recorded and stored in a storage medium that is accessible by a computing device or processor. For example, information regarding which accounts were accessed and who accessed those accounts may be recorded in a database. In other examples, information regarding actions taken by an individual associated with the entity may be recorded and saved in a database, file, or other data store, and interactions with accounts may be identified within such saved actions.

Element 120 also contemplates that the determination period be a predetermined time period prior to the abnormal event or notification of the abnormal event. It will be appreciated that while, in some circumstances, the abnormal event and notification of the abnormal event will occur contemporaneously or otherwise close in time, there need not be any temporal relationship between the abnormal event and notification of the abnormal event. For example, since many entities, such as banks, actively monitor transactions for signs of fraud or other unauthorized behavior, it is possible that the abnormal event will be detected before a customer notifies the entity of a potentially abnormal event. In other examples, there may be no notification of the abnormal event, but the abnormal event may be discovered in the course of a review of transactions or account activity. In other examples, an entity may receive a notification from a customer, law enforcement agency, or other third party that has information indicating that an abnormal event has occurred or is likely to occur.

It will be appreciated that the predetermined time period may be any time period. In some example implementations, the predetermined time period is thirty, sixty, or ninety days. However, in some situations, example implementations may utilize a longer time period, such as six months or a year or more. Since each abnormal event may be the product of different behaviors, both innocent and nefarious, predetermined time periods of differing length may be utilized to address different situations.

In some example implementations of determining which individuals associated with the entity interacted with customer accounts in the claims data during a predetermined time period prior to the abnormal event or notification of the abnormal event, a computing device or other processor queries a database or other computer-readable storage medium to analyze the claims data. In some other example implementations, a computing device or other processor may access data from multiple sources to identify individuals and their interactions with customer accounts and compare that information to the claims data. However, it will be appreciated that any approach to determining which individuals associated with the entity interacted with customer accounts in the claims data during a predetermined time period prior to the abnormal event or notification of the abnormal event may be used.

Element 130 includes providing for a suspect list that includes the individuals determined to have interacted with a customer account in the claims data. In some example implementations, the suspect list includes all individuals determined to have interacted with a customer account in the claims data. In such implementations, the suspect list may be ordered in accordance with any predetermined or user-selected criteria, such as number of customer account interactions, perceived severity of the abnormal event, and/or chronology of the interaction or the abnormal event. It will be appreciated, however, that the suspect list need not reflect any order. In some other examples, the suspect list is a subset of all the individuals determined to have interacted with a customer account in the claims data. For example, the suspect list may include the individuals with more than a threshold number of customer account interactions, or individuals who interacted with accounts with claims that match predetermined criteria for potential severity.

It will be appreciated that any approach to providing for a suspect list that includes the individuals determined to have interacted with a customer account in the claims data may be used. In some example implementations, a list identifying the individuals and their interactions is presented on a screen and/or transmitted to an investigator. In some example implementations, the suspect list includes additional information about the individual and/or their interactions to assist an investigator in evaluating the individuals listed on the suspect list.

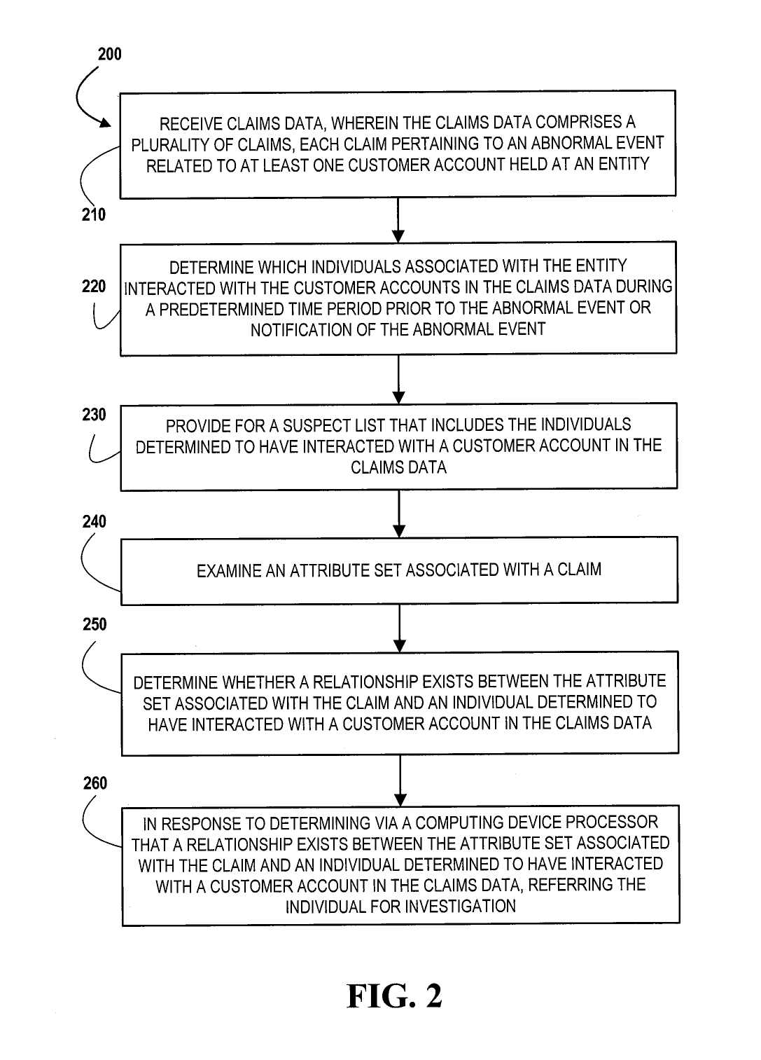

Turning to FIG. 2, a method 200 is presented which includes elements 210-260. As depicted in FIG. 2, element 210 includes receiving claims data that includes a plurality of claims. Each claim in the claims data pertains to an abnormal event related to at least one customer account held at an entity. It will be appreciated that any approach used in implementations of element 110, as shown in FIG. 1, may be used in implementations of element 210.

As shown in FIG. 2, element 220 includes determining which individuals associated with the entity interacted with the customer accounts in the claims data during a predetermined time period prior to the abnormal event or notification of the abnormal event. It will be appreciated that any approach used in implementations of element 120, as shown in FIG. 1, may be used in implementations of element 220.

Also shown in FIG. 2 is element 230, which includes providing for a suspect list that includes the individuals determined to have interacted with a customer account in the claims data. It will be appreciated that any approach used in implementations of element 130, as shown in FIG. 1, may be used in implementations of element 230.

Method 200 also includes element 240, which includes examining an attribute set associated with a claim. Also shown is element 250, which includes determining whether a relationship exists between the attribute set associated with the claim and an individual determined to have interacted with a customer account in the claims data.

Also shown in FIG. 2 is element 260, which includes, in response to determining that a relationship exists between the attribute set associated with the customer claim and an individual determined to have interacted with a customer account in the claims data, referring the individual for investigation.

As presented in element 240, some example implementations of the method 200 contemplate an attribute set associated with a claim. In some situations, the attribute set provides additional information that allows for claims within the claims data to be characterized and/or grouped with other claims within the claims data. By identifying similarities and differences between aspects of various claims, patterns may become apparent that impact the investigation of such claims. In situations where some claims share one or more attributes, investigation resources may be reallocated to allow for claims that may have a common cause or other aspect to be investigated together.

The attribute set may include any information related to the claim. For example, the attribute set may include information about the customer. In some such implementations, the attribute set may include a name of a customer associated with a claim. In some situations, a customer may be the target of an attack on many or all of the customer's accounts, and recognizing that one customer is the source of many claims may clarify a subsequent investigatory process.

In some of implementations where the attribute set includes information about the customer, the attribute set includes demographic information associated with a customer. For example, the demographic information includes the age, race, ethnicity, religious affiliation, country of origin, and/or any other type of demographic information. Identifying a demographic factor that is common to many claims may allow an investigation to identify a motive or target of individuals who misappropriate and misuse customer account information.

In some implementations where the attribute set includes information about the customer, the attribute set includes a job title associated with the customer. For example, it may be beneficial to an investigation to identify if a particular profession or sector of the employment market has experienced an abnormally high prevalence of abnormal events.

The attribute set may also include geographic and/or location information. For example, the attribute set may include a geographic area, such as an address, neighborhood, city, region, district, or other area associated with the claim and/or the customer. In some other examples, the attribute set includes a distance between a location associated a first claim and a location associated with a second claim. In some situations, identifying instances where multiple claims are concentrated in a particular area may expedite and/or clarify an investigation.

The attribute set may also include information related to time. For example, the attribute set may include a period of time, such as a portion of a day, a day, a week, a month, and/or any other period of time. The period of time may also be referenced to an occurrence or event. The attribute set may also include a time of day, such as a time of day when an abnormal event occurred or when the abnormal event was noticed.

In some example implementations, the attribute set includes financial institution information (e.g., bank). Any information that relates to a customer's financial institution behaviors, affiliations, or other relationships with a financial institution may be considered financial institution information. Information regarding any behavior, affiliation or other relationship between a financial institution and an abnormal event may also be considered financial institution information. For example, financial institution information may include, but is not limited to a financial institution name, a financial institution branch identification number, an employee name, a check number, and a bank routing number.

As shown in FIG. 2, element 250 includes determining whether a relationship exists between the attribute set associated with the claim and an individual determined to have interacted with a customer account in the claims data. Any approach to determining whether a relationship exists between the attribute set and an individual may be used in example implementations of element 250. For example, a computing device processor or other processor may identify similarities among claims for each claim associated with an individual. In other example implementations, claims within the claims data may be grouped according to similar attributes in their respective attribute sets and cross-referenced with the individuals who interacted with the customer accounts associated with each claim.

It will be appreciated that a relationship between an attribute set and an individual may include any correlation between the individual and the attribute set. For example, if an individual is determined to have interacted with multiple customer accounts that share one or more attribute, a relationship exists between the individual and an attribute set. In another example, a correlation between traits, aspects, or other attributes of the individual and attributes of a claim is a relationship between the individual and the attribute set.

As shown in FIG. 2, element 260 includes, in response to determining that a relationship exists between the attribute set associated with the customer claim and an individual determined to have interacted with a customer account in the claims data, referring the individual for investigation. It will be appreciated that any approach to referring an individual for investigation may be used. In some example implementations, the existence of a relationship between an attribute set and an individual identifies the individual as a priority target for investigation. In some other example implementations, the existence of a relationship between an attribute set and an individual suggests that additional investigation or monitoring of the individual's actions may be necessary to ensure that abnormal events do not arise from actions undertaken by the individual.

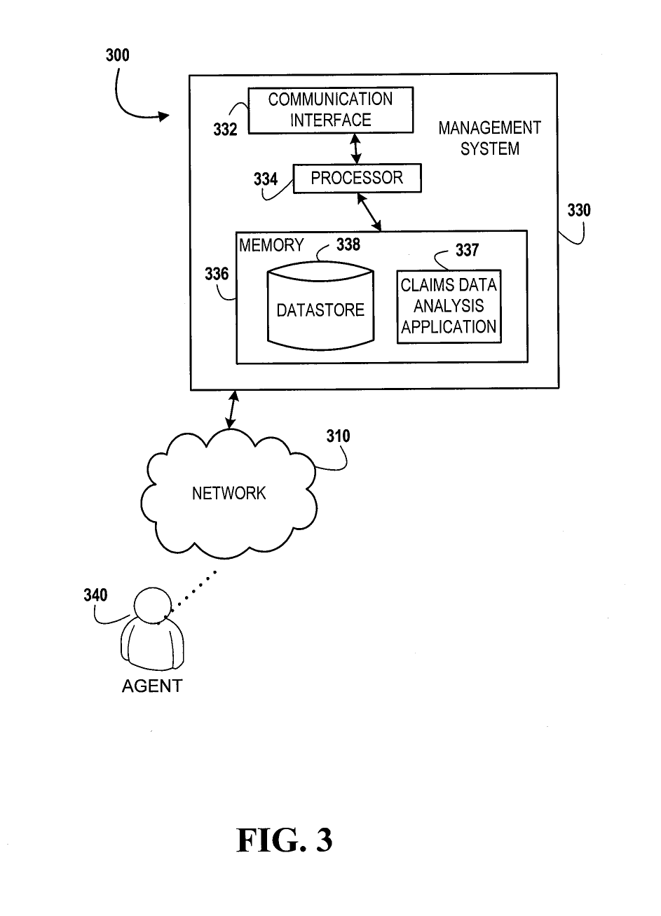

FIG. 3 presents a system 300 for performing claims data analysis in accordance with an embodiment of the present invention. As shown, system 300 includes a network 310, a management system 330, and an agent 340. In the example embodiment depicted in FIG. 3, the management system 330 is maintained by an entity, and the agent 340 is a representative of an entity, such as a financial institution or other entity, such as a retailer, service provider, private club, and/or organization that is subject to claims pertaining to an abnormal event related to a customer account held at the entity. In some example implementations, the agent 340 is an investigator assigned by the entity to investigate claims.

As shown in FIG. 3, the management system 330 is operatively and selectively connected to the network 310, which may include one or more separate networks. The agent 340 is able to access the network 310, and may do so using any computerized device capable of interacting with a network, such as a computer, secure network terminal, mobile device, or other device. In addition, the network 310 may include a local area network (LAN) such as an intranet, a wide area network (WAN), and/or a global area network (GAN), such as the Internet. It will also be understood that the network 310 may be secure and/or unsecure and may also include wireless and/or wireline and/or optical interconnection technology.

As depicted, the management system 330 may include any computerized apparatus that can be configured to perform any one or more of the functions described and/or contemplated herein. In accordance with some embodiments, for example, the management system 330 may include a computer network, an engine, a platform, a server, a database system, a front end system, a back end system, a personal computer system, and/or the like. In some embodiments, such as the one illustrated in FIG. 3, the management system 330 includes a communication interface 332, a processor 334, and a memory 336, which includes a datastore 338 and a claims data analysis application 337. As shown, the communication interface 332 is operatively and selectively connected to the processor 334, which is operatively and selectively connected to the memory 336.

A communication interface, such as communication interface 332, generally includes hardware, and, in some instances, software, that enables a portion of the system 300, such as the management system 330, to transport, send, receive, and/or otherwise communicate information to and/or from the communication interface of one or more other portions of the system 300. For example, the communication interface 332 of the management system 330 may include a modem, server, electrical connection, and/or other electronic device that operatively connects the management system 330 to another electronic device, such as the electronic devices that make up and/or communicate with the network 310.

Each processor described herein, including the processor 334, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the claims data analysis application of the memory 336 of the management system 320.

Each memory device described herein, including the memory 338 for storing the claims data analysis application 337 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

It will be appreciated that the claims data analysis application 337 may be configured to implement any one or more portions of any one or more of the process flows 100 and/or 200 described and/or contemplated herein. As an example, in some embodiments, the claims data analysis application 337 is configured to receive claims data, wherein the claims data comprises a plurality of claims, each claim pertaining to an abnormal event related to at least one customer account held at an entity; determine which individuals associated with the entity interacted with the customer accounts in the claims data during a predetermined time period prior to the abnormal event or notification of the abnormal event; and provide for a suspect list that includes the individuals determined to have interacted with a customer account in the claims data.

In some further example implementations, the claims data analysis application 337 is further configured to examine an attribute set associated with a claim and determine whether a relationship exists between the attribute set associated with the claim and an individual determined to have interacted with a customer account in the claims data.

In further example implementations, the claims data analysis application 337 is further configured to, in response to determining that a relationship exists between the attribute set associated with the claim and an individual determined to have interacted with a customer account in the claims data, refer the individual for investigation.

It will be understood that the claims data analysis application 337 may be configured to perform any of the methods described herein, including, without limitation, those shown and described with respect to FIG. 1 and FIG. 2. It will also be understood that in some implementations, claims data analysis application 337 may be configured to cause the management system 330 to be configured to transmit and receive information, such as information related to claims and/or the investigation of claims, from the agent 340. It will also be understood that, in some embodiments, the claims data analysis application 337 is configured to communicate with the datastore 338, and/or any one or more other portions of the system 300.

It will be further understood that, in some embodiments, the claims data analysis application 337 includes computer-executable program code portions for instructing the processor 334 to perform any one or more of the functions of the claims data analysis application 337 described and/or contemplated herein. In some embodiments, the claims data analysis application 337 may include and/or use one or more network and/or system communication protocols.

In addition to the claims data analysis application 337, the memory 336 also includes the datastore 338. As used herein, the datastore 338 may be one or more distinct and/or remote datastores. In some embodiments, the datastore 338 is not located within the management system 330 and is instead located remotely from the management system 330. In some embodiments, the datastore 338 stores information regarding one or more claims and/or one or more sets of claims data.

It will be understood that the datastore 338 may include any one or more storage devices, including, but not limited to, datastores, databases, and/or any of the other storage devices typically associated with a computer system. It will also be understood that the datastore 338 may store information in any known way, such as, for example, by using one or more computer codes and/or languages, alphanumeric character strings, data sets, figures, tables, charts, links, documents, and/or the like. Further, in some example embodiments, the datastore 338 may include information associated with one or more applications, including, but not limited to, the claims data analysis application 337. It will also be understood that, in some embodiments, the datastore 338 provides a substantially real-time representation of the information stored therein, so that, for example, when the processor 334 accesses the datastore 338, the information stored therein is current or substantially current.

It will be understood that the embodiment illustrated in FIG. 3 is exemplary and that other embodiments may vary. As another example, in some embodiments, the management system 330 includes more, less, or different components, such as, for example, a user interface. As another example, in some embodiments, some or all of the portions of the system 300 may be combined into a single portion. Likewise, in some embodiments, some or all of the portions of the system 300 may be separated into two or more distinct portions.

It will also be understood that the system 300 may include and/or implement any embodiment of the present invention described and/or contemplated herein.

Thus, as described herein, embodiments of the invention provide for claims data analysis. The methods, apparatus and computer program products described in more detail below provide for receiving claims data, wherein each claim pertains to an abnormal event related to at least one customer account held and an entity, and determining which individuals associated with that entity interacted with the customer accounts in the claims data. In addition, some of the embodiments contemplate examining an attribute set associated with a claim and determining whether a relationship exists between the attribute set and an individual who has interacted with a customer account in the claims data.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for claims data analysis, the method comprising:
receiving, via a computing device, claims data, wherein the claims data comprises a plurality of claims, each claim pertaining to an abnormal event related to at least one customer account held at an entity;
determining, via a computing device processor, which individuals associated with the entity interacted with the customer accounts in the claims data during a predetermined time period prior to the abnormal event or notification of the abnormal event; and
providing, via a computing device processor, for a suspect list that includes the individuals determined to have interacted with a customer account in the claims data.

2. The method of claim 1 further comprising:
examining via a computing device processor an attribute set associated with a claim; and
determining via a computing device processor whether a relationship exists between the attribute set associated with the claim and an individual determined to have interacted with a customer account in the claims data.

3. The method of claim 2 further comprising:
in response to determining via a computing device processor that a relationship exists between the attribute set associated with the claim and an individual determined to have interacted with a customer account in the claims data, referring the individual for investigation.

4. The method of claim 2 wherein the attribute set comprises a name of a customer associated with a claim.

5. The method of claim 2 wherein the attribute set comprises a geographic area.

6. The method of claim 2 wherein the attribute set comprises a distance between a location associated a first claim and a location associated with a second claim.

7. The method of claim 2 wherein the attribute set comprises a period of time.

8. The method of claim 2 wherein the attribute set comprises a time of day.

9. The method of claim 2 wherein the attribute set comprises a job title associated with a customer.

10. The method of claim 2 wherein the attribute set comprises a set of banking information.

11. The method of claim 10 wherein the set of banking information comprises at least one piece of information selected from the group including: a bank name, a bank branch identification number, an employee name, a check number, and a bank routing number.

12. The method of claim 2 wherein the attribute set comprises demographic information associated with a customer.

13. An apparatus for analyzing a customer claim, the apparatus comprising:
a computing device comprising a memory and at least one processor; and
a claims data analysis application stored in the memory, executable by the processor, and configured to:
receive claims data, wherein the claims data comprises a plurality of claims, each claim pertaining to an abnormal event related to at least one customer account held at an entity;
determine which individuals associated with the entity interacted with the customer accounts in the claims data during a predetermined time period prior to the abnormal event or notification of the abnormal event; and
provide for a suspect list that includes the individuals determined to have interacted with a customer account in the claims data.

14. The apparatus of claim 13 wherein the claims data analysis application is further configured to:
examine an attribute set associated with a claim; and
determine whether a relationship exists between the attribute set associated with the claim and an individual determined to have interacted with a customer account in the claims data.

15. The apparatus of claim 14 wherein the claims data analysis application is further configured to:
in response to determining that a relationship exists between the attribute set associated with the claim and an individual determined to have interacted with a customer account in the claims data, refer the individual for investigation.

16. The apparatus of claim 14 wherein the attribute set comprises at least one attribute selected from the group including: a name of a customer associated with a claim, a geographic area, a distance between a location associated a first claim and a location associated with a second claim, a period of time, a time of day, a job title associated with a customer, a set of banking information, and demographic information associated with a customer.

17. The apparatus of claim 16 wherein the set of banking information comprises at least one piece of information selected from the group including: a bank name, a bank branch identification number, an employee name, a check number, and a bank routing number.

18. A computer program product comprising:
a non-transitory computer-readable medium comprising:
a first set of codes for causing a computer processor to be configured for receiving claims data, wherein the claims data comprises a plurality of claims, each claim pertaining to an abnormal event related to at least one customer account held at an entity;
a second set of codes for causing a computer processor to be configured for determining which individuals associated with the entity interacted with the customer accounts in the claims data during a predetermined time period prior to the abnormal event or notification of the abnormal event; and
a third set of codes for causing a computer processor to be configured for providing for a suspect list that includes the individuals determined to have interacted with a customer account in the claims data.

19. The computer program product of claim 18 further comprising:
a fourth set of codes for causing a computer processor to be configured for examining an attribute set associated with a claim; and
a fifth set of codes for causing a computer processor to be configured for determining whether a relationship exists between the attribute set associated with the claim and an individual determined to have interacted with a customer account in the claims data.

20. The computer program product of claim 19 further comprising:
a sixth set of codes for causing a computer processor to be configured for, in response to determining that a relationship exists between the attribute set associated with the claim and an individual determined to have interacted with a customer account in the claims data, referring the individual for investigation.

21. The computer program product of claim 19 wherein the attribute set comprises at least one attribute selected from the group including: a name of a customer associated with a claim, a geographic area, a distance between a location associated a first claim and a location associated with a second claim, a period of time, a time of day, a job title associated with a customer, a set of banking information, and demographic information associated with a customer.

22. The computer program product of claim 21 wherein the set of banking information comprises at least one piece of information selected from the group including: a bank name, a bank branch identification number, an employee name, a check number, and a bank routing number.
